(19) United States
(12) Patent Application Publication
(10) Pub. No.: US 2026/0252344 A1
(43) Pub. Date: Aug. 27, 2026

(54) EPHEMERAL VALUES IN CLOUD INFRASTRUCTURE PLANNING

(71) Applicant: HashiCorp, San Francisco, CA (US)

(72) Inventors: Radek Simko, San Francisco, CA (US); Austin Valle, San Francisco, CA (US); Katy Moe, San Francisco, CA (US)

(21) Appl. No.: 19/061,846

(22) Filed: Feb. 24, 2025

(51) Int. Cl. G06F 8/71; G06F 9/455

(52) U.S. Cl. CPC G06F 8/71; G06F 9/45512

(57) ABSTRACT

A system and method for planning IT infrastructure using ephemeral attribute values for a configuration of the IT infrastructure. A system includes an infrastructure as code (IaC) tool configured to manage a IT infrastructure according to at least one plan file and at least one state file. The IaC tool including a syntax structure configured to designate one or more of the values as ephemeral so that each designated value is not persisted in the at least one plan file or in the at least one state file. The system further includes a user interface having a command line interface for receiving input to create the at least one plan file.

### TECHNICAL FIELD

The subject matter described herein relates to information technology (IT) infrastructure, and more particularly to an infrastructure-as-code (IaC) tool for infrastructure management using ephemeral values for handling secrets in a stateless manner and separate from an infrastructure plan or state.

### BACKGROUND

Information technology (IT) infrastructure may refer to the hardware resources, software resources, and/or network resources forming an enterprise's information technology environment. For example, hardware resources may include servers, computers, data centers, switches, hubs, routers, and/or the like. Meanwhile, software resources may include enterprise resource planning (ERP) software applications, customer relationship management (CRM) software applications, productivity software applications, and/or the like. The network resources of the enterprise's information technology infrastructure may include any resources providing network enablement, network connectivity, network security, and/or the like.

The information technology infrastructure of the enterprise may enable the delivery of information technology services and/or solutions to a variety of internal and external users including, for example, employees, partners, customers, and/or the like. For instance, the hardware resources of the enterprise's information technology infrastructure may be used to host the software resources. At least some of the software resources within the enterprise's information technology infrastructure may be available remotely, for example, as a software-as-a-service (SaaS), a web application, and/or the like. Remote access to these software resources may be enabled and/or regulated by the network resources within the enterprise's information technology infrastructure.

An infrastructure-as-code (IaC) tool for cloud infrastructure management such as Terraform by HashiCorp can be used to manage many types of resources, including hardware devices, software applications, cloud infrastructure, and more. Resources can be configured with one or more attributes, which can be used to map resources to infrastructure from providers, which can be provided in the form of plug-ins that extend Terraform support to external systems.

In one example, secrets, such as private keys, certificates, API tokens, etc., get stored in a state file (i.e., a mapping of managed IT resources to an IT configuration, also referred to herein simply as “state”), and a plan file (i.e., an execution plan for provisioning the IT resources, also referred to herein simply as “plan”) of the IaC tool. In an IaC planning and management tool such as Terraform, the state file acts as a record of existing resources, storing details about the resources created in accordance with a configuration of the infrastructure, while the plan file is a snapshot of the proposed changes to the infrastructure based on a comparison between the current configuration and the state file. Essentially, state is the reference point used to generate a plan outlining necessary modifications to reach the desired infrastructure state defined in the configuration.

However, storing secrets resources in state can lead to security vulnerabilities and inadvertent disclosure of those secrets to unauthorized parties. While Terraform manages the resource(s) that contains a secret, Terraform may not necessarily need to manage or retain the secret value itself. While there may be some secrets that Terraform must keep in state in some capacity, whether as raw values or proxies for the values of the secrets, in the majority of use cases Terraform does not need to store the secret in state, such as where the sensitive value is used only for creating/updating a particular configuration attribute. Storing secrets in state even though they do not need to be managed by Terraform makes it difficult for providers to allow for more advanced and highly secure operations.

Providers today comprise of any or a combination of the following: a managed resource, data resource(s) and function components. Managed resources are components that support create, read, update, and delete (CRUD) operations and are managed using remote procedure calls (RPCs) over a provider protocol. Data resources are components that are intended to support a read-only lookup. Functions are components that receive positional arguments as input, perform function logic, then produce a single value as a result

Managed resources and data resources are used for a variety of sensitive reasons that can lead to the unintended side effect of storing secrets in state. For example, a data resource can be used to fetch a secret and use that secret as input into another resource or another Terraform object. That data resource is stored in state, and therefore the secret is also stored in state, even though it may have been used only for the creation of a resource.

Another potential problematic scenario arises when a secret a generated by Terraform as an input to another resource. One example of this occurs when Terraform uses the transport layer security (TLS) provider or a random number provider, with the intent to use that generated secret (TLS certificate or random number) as input into another resource. However, the generated secret resource is stored in state alongside its secret input, whereas the intention is for the generated secret to only exist within the lifetime of the Terraform operation and for it to exist in a remote system and not in Terraform state.

In the above two examples, a user is fetching or generating a secret to be used elsewhere, and the secret is unintentionally persisted in state in the origin object that is not necessarily using it. Often, a resource may contain a sensitive field (such as, for example, the initial password for an IT system), but that field is only relevant during initial creation or subsequent updates. The value for the sensitive field is passed in as an input (e.g., an external data source or a user provided variable). This configuration attribute is never intended to be managed by Terraform because the practitioner either stores the value elsewhere or the value is derived from a known source.

What is needed is an ability to designate attribute values of IT resources as ephemeral, so that such designated attribute values are not stored in a plan file or state file after an apply phase of provisioning IT infrastructure based on a plan phase.

### SUMMARY

This document introduces new constructs for use by an IaC tool and system to enable IT resources, as represented by one or more attribute values, to be designated as ephemeral, in which the designated attribute values will not be stored in state, plan, or any artifact thereof.

In some aspects, a system and method for planning cloud infrastructure using ephemeral values for a configuration of the cloud infrastructure are presented. In a particular aspect, a system includes an infrastructure as code (IaC) tool configured to manage an IT infrastructure according to at least one plan file and at least one state file, each plan file comprising attribute values that define a configuration or proposed changes of the configuration of IT resources to be applied in an apply phase to create, update, or delete resources for the IT infrastructure, each state file representing the IT resources of the existing infrastructure, the configuration comprising one or more of input variables, resources, data sources, output variables, secrets resources, the IaC tool including a syntax structure configured to designate one or more of the values as ephemeral so that each designated value is not persisted in the at least one plan file or in the at least one state file to provision the IT infrastructure. The system further includes a user interface having a command line interface for receiving input and performing operations.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an information technology, cloud-based infrastructure configuration system and method, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter; and

FIG. 2 shows a process flow diagram illustrating aspects of a method having one or more features consistent with implementations of the current subject matter.

When practical, similar reference numbers denote similar structures, features, or elements.

### DETAILED DESCRIPTION

To overcome the challenges and shortcomings of conventional IT infrastructure management tools inadvertently persisting secrets, ephemeral values are introduced. An ephemeral value has an additional piece of metadata that travels with it to derived values but does not change the value itself, through a number of new language constructs configured to designate ephemerality to: variables, inputs, outputs, resources, and write-only resource attributes. A feature of each of these constructs is ephemeral configuration context, in which the value expression of the construct is ephemeral, so it can contain references to ephemeral values.

Ephemeral resources have new lifecycle handlers for generating and maintaining ephemeral values. Ephemeral resources can have similar schema definitions as managed resources and the data will be bound by the same IaC system. Managed resource schemas are updated with a write-only attribute behavior to allow ephemeral values to be passed to the managed resource lifecycle handlers without being persisted to plan or state files.

These constructs allow an IaC tool to handle temporary objects throughout the lifecycle of an operation, and to perform a dynamic analysis that ensures that by default any result derived from an ephemeral value is considered ephemeral itself. Ephemeral data does not get persisted, and more specifically, values marked as ephemeral will not get persisted in the state file or the plan file. The user interface and implementation can further be configured to guide the user to avoid persisting the values unless the user explicitly asks a program other than the IaC tool to do so.

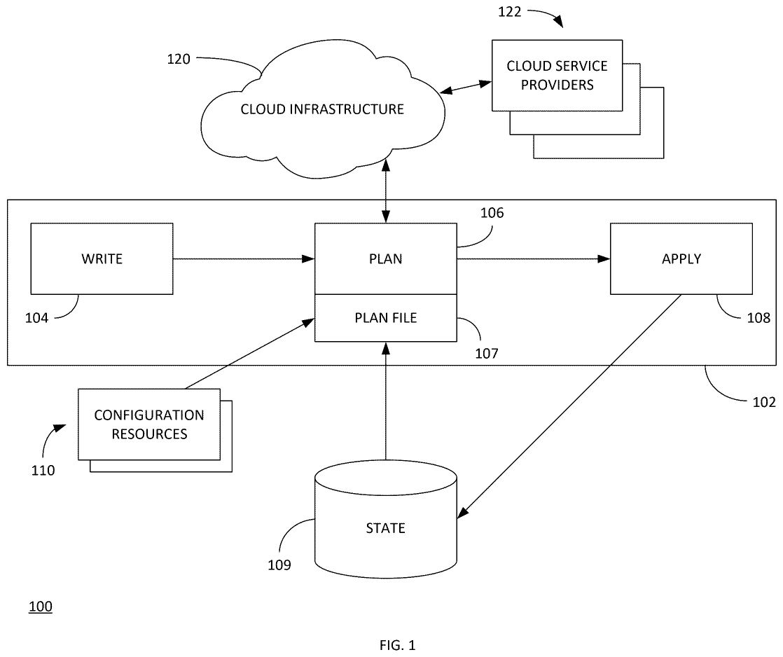

FIG. 1 illustrates an IaC system 100 having an IaC tool 102 for planning configuring and managing IT infrastructure 120. The IaC tool 102 includes a write module 104 for receiving user input, for example via a command line interface, by which a planning module 106 configures a plan of configuration resources 110 and cloud services from one or more cloud service providers 122 for the planned IT infrastructure.

The planning module 106 generates a plan file 107, which includes attribute values that define a configuration or proposed changes of the configuration resources 110 to be applied in an apply phase by an apply module 108, to provide an existing infrastructure plan for the IT infrastructure 120. The configuration is persisted in a state file 109, which acts as a record of existing IT infrastructure, storing details about the resources created in accordance with the plan file 107. It is advantageous that some attribute values of the configuration resources, such as, for example, input variables, secrets resources, connection resources, and write-only resource attributes, are not persisted in either the state file 109 or the plan file 107, and expressions of these resources can be designated as “ephemeral.”

Ephemerality of an expression can be gained both explicitly and implicitly. Explicitly means that the value, such as an input variable, is explicitly set to “ephemeral” where it is declared in the configuration. Most ephemeral values should be explicitly set. However, some ephemeral values are ephemeral despite their declaration in configuration not mentioning the ephemerality, so they gain it implicitly. This includes local variables that reference ephemeral variables. In general, any expression referencing an ephemeral value will have implied ephemerality.

In some implementations, this behavior can be specified in the configuration, e.g, in the command line interface (CLI) input of the core of the IaC tool, as exemplified as below, in which ephemerality can be specifically designated for a variable:

```
variable “example” {
  type = string
  ephemeral = true
}
```

Ephemeral variables can be supplied the same way as non-ephemeral, i.e., via CLI flag-var, -var-file, via automatically loaded variable files (terraform.tfvars), via environment variables TF_example or via interactive prompt. In preferred implementations, designation of ephemerality, or a lack of designation thereof, can guarantee application of such designation in all cases. Alternatively, a user can even decide to supply values via a tfvars file, which is persisted on disk or even stored in a version control system but is not stored as part of the plan operation or the state in Terraform. In case of the interactive prompt by the IaC tool, in some implementations because the values are not to be persisted between plan and apply, users can be prompted for the same ephemeral variables during each operation again.

The same ephemeral behavior will also become available for variables declared inside of modules, acting as module inputs. This implies that any such input only accepts references to ephemeral values (e.g., ephemeral variable or write-only attribute) and cannot be hard-coded inside of the module block. Non-ephemeral (existing) variable values are not persisted directly, but the values may end up in state indirectly—as a result of the variable being referenced in a resource, data source, local value, or an output. Ephemeral variables are not persisted even indirectly, as described in more detail below.

In preferred implementations, ephemerality cannot be removed later. The only way of removing ephemerality of an expression is to turn it into null via a dedicated new function ephemeralasnull( ). Thus, once a value becomes ephemeral, then it should not be persisted in the state file.

In preferred implementations, the following restrictions apply. First, an ephemeral variable can only be referenced in: another ephemeral value's validation; an ephemeral module input; a managed resource's write-only attribute; an ephemeral resource's attribute; an implied ephemeral block's attribute; or a root module's ephemeral output. Second, an ephemeral attribute of a managed resource or ephemeral resource can only be referenced in: a managed resource's write-only attribute; an ephemeral resource's attribute; an ephemeral module input; an implied ephemeral block's attribute; or an ephemeral output (both root and child module). Third, an ephemeral child module output can only be referenced in: a managed resource's write-only attribute; an ephemeral resource's attribute; an ephemeral module input; an implied ephemeral block's attribute; or a root module's ephemeral output. If any of the above restrictions are violated, a blocking error will be raised. Certain configuration blocks already behave as ephemeral in the sense that Terraform doesn't persist the data in state (provider, provisioner, connection, etc.), and these blocks will maintain their existing behavior, effectively aligning them with the more explicitly ephemeral parts of configuration being introduced.

Diagnostics may include ephemeral values since sensitivity remains a separate behavior. i.e., ephemerality does not imply sensitivity. If any systems around the IaC tool persist diagnostics, then while it may violate the intention/guarantee of “non-persistence,” it is the decision of that system/user, rather than something the IaC tool core aims to prevent. In fact, such an exposure and potential persistence may aid debugging.

In accordance with preferred implementations of the present subject matter, ephemeral values are never stored in any file such as the plan or state. Further, ephemeral values can only exist within the lifetime of an operation. And a fresh value is presented during each operation.

Ephemeral values, whatever source they come from, should only be set in another ephemeral destination, such as ephemeral resources, write-only attributes of managed resources, provider configurations or provisioners, or the like. If an ephemeral value is used as part of a local value or function (built-in or provider defined functions), then that local value/function becomes an ephemeral value and adheres to the same rules above. Non-ephemeral values can be set anywhere, including ephemeral resources, ephemeral input values, ephemeral output values, and write-only attributes of managed resources, as explained in further detail below.

### Ephemeral Inputs

When the language includes the ability to track ephemerality of values, a specific input variable can be declared to be ephemeral, as exemplified below:

| variable “aws_jwt” { | |
|---|---|
| type | = string |
| sensitive | = true |
| ephemeral | = true |

}

In the example above, the value obtained by a reference like var.aws_jwt is marked as ephemeral, making it invalid to use in locations where persistence is required. If the variable is declared in the root module, the IaC tool will no longer save the value in a plan file, and instead the operator must provide a value again during the apply phase. Accordingly, the IaC tool can pass an input in a time-limited credential during the plan phase without the risk that it would have expired by the apply phase, because providing a new credential (that has equivalent access) during the apply phase is acceptable.

Input variables can be marked as ephemeral. Ephemeral input can be provided for every operation, unless otherwise specified as part of a default value, but the plan will not store the values of the ephemeral input variables and will instead store only placeholders. The designation of ephemeral input variables does not imply “sensitive,” which is focused on the UI. If the user wants an ephemeral input variable to not be displayed, then it can be marked as sensitive. Otherwise, it will be displayed. There can be use cases in which the user does want to display an ephemeral value, such as with credentials, API tokens, or other security sensitive values.

### Ephemeral Outputs

An output may be declared as ephemeral. If so, its value should never be saved to the state or plan file, and may only appear as part of an IaC tool's “apply” output as both JSON and human-readable form. An example is as follows:

```
output “example” {
  ephemeral = true
  value = var.example
}
```

In some implementations, the output value should be explicitly declared as ephemeral. If it is not, then the IaC tool will generate an error if the user attempts to assign it an ephemeral value (e.g. if var.example is ephemeral). One design principle is to prefer explicitness wherever possible, and “fail closed” by making it difficult for the user to use an ephemeral value in a context they do not consider ephemeral.

In general, any given output may be ephemeral, sensitive, both, or neither. In addition, an output's ephemerality or sensitivity may change as part of a plan. The plan should render all changes in outputs including combinations of “sensitive before”, “sensitive after”, “ephemeral before”, and/or “ephemeral after”.

### Ephemeral Resources

A new type of resource (ephemeral resource) is introduced to the language, represented by an ephemeral block of the same structure as resource, and particularly a managed resource, as exemplified below:

| ephemeral “random_password” “password” { | |
|---|---|
| length | = 16 |
| special | = true |
| override_special | = “!#$%&*( )−_=+[ ]{ }<>:?” |

}

In some implementations, only the bare minimum data is persisted in state, mainly to aid with graph building, planning, and execution. Attributes or attribute values of ephemeral resources are not persisted. Sensitive attribute names can however be persisted, to ensure that any ephemeral values which also happen to be sensitive are also redacted in the UI where we would otherwise display the momentarily available (ephemeral) values.

Accordingly, the feature of ephemeral resources can be implemented, and declared with ephemeral blocks. An access token can be used as the sole credential issued directly to the IaC tool, and then the IaC tool could obtain other credentials dynamically at runtime. Thus, output values can be marked as ephemeral, which results in the plan and/or state storing only placeholders for the ephemeral values and not the values themselves.

In accordance with some implementations, a new ephemeral resource maps to a new provider ephemeral resource mode. This sits alongside a managed resource and data source. The ephemeral resource has a set of attributes defined by a schema that is declared in the IaC tool provider. Non-ephemeral values can be set in the attributes of ephemeral resources, but the ephemeral resource can only be referenced in other ephemeral values such as write-only attributes, provider configuration, other ephemeral resources, and ephemeral output values.

Preferably, ephemeral resources can be displayed in the output, but will adhere to any sensitive rules that are applied to it via the sensitive( ) function or provider based sensitivity in the schema. The ephemeral resources have lifecycle handlers that allow them to maintain the ephemerality of the object in question throughout the full plan or apply operation. The ephemeral resources will only be used during the lifetime of the operation, for each operation as a fresh execution, and will not be able to be referenced in any configuration-driven state operation such as import { }, moved { } or removed { }.

### Managed Resources Write-Only Attributes

In some implementations, from the perspective of the IaC tool, there is no conflict between “required” and “write-only” resource configuration attributes. The IaC tool can be configured to ensure both that the “requiredness” is validated, i.e., the attribute value is provided and that the provided value is not persisted. In some implementations, the engine of the IaC tool can be configured to raise error diagnostic when a write-only attribute is hard-coded in the configuration, such that users may be forced to leverage variables or references to other ephemeral configuration contexts to ensure the value does not get persisted in configuration.

In accordance with preferred implementations, a write-only attribute will be set and passed to the underlying cloud provider when there is a non-null value assigned to the attribute. A value of null will be interpreted as “do not set.” Write-only attributes will accept both ephemeral and non-ephemeral values. Write-only values will always be stored as null in state. If a write-only attribute is set to null during the plan phase, it must be null in the apply phase. Conversely, if it is set to a non-null value during plan, it must be set to a non-null value during apply. The plan should know whether a write-only attribute is null or non-null, without ever storing the value itself. Write-only attributes will be read as ephemeral and can only be referenced in other ephemeral destinations. A write-only attribute will be set to null in state.

In some implementations, an ephemeral resource can have three lifecycle functions: one for the beginning of the operation (i.e., “begin” or “open”), one for the end of the operation (i.e., “end” or “close”), and one for renewing the ephemerality of the resource (i.e., “renew”). These new lifecycle functions or events are introduced to the provider protocol and used during the plan and apply steps of the operation of the IaC tool.

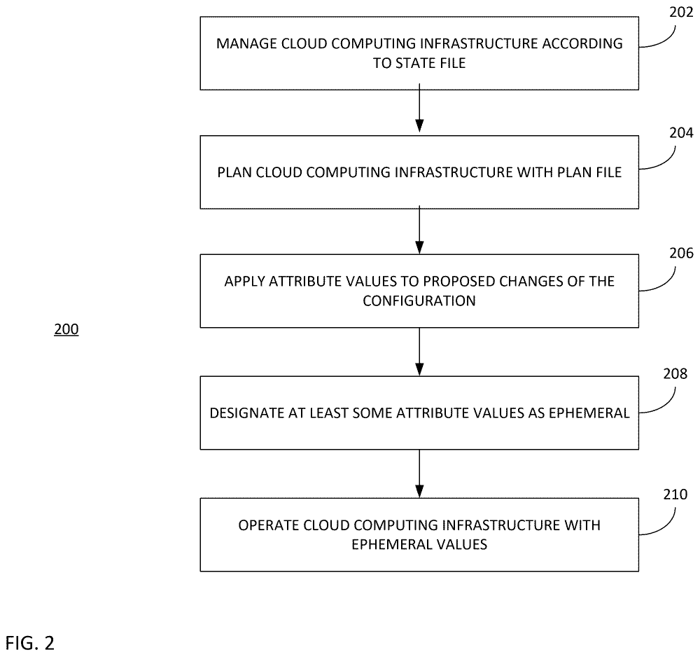

FIG. 2 is a flowchart of an exemplary method 200 of planning, managing and operating a IT infrastructure using designated ephemeral values. At 202, a state file is generated by which an IaC system manages and operates the IT infrastructure. Each state file represents the IT resources of the existing infrastructure based on the apply phase of the plan file and configuration, the configuration comprising one or more of input variables, outputs, resources, ephemeral resources, among other attributes.

At 204, the IT infrastructure is planned based on a plan file. Each plan file includes attribute values that define a configuration or proposed changes of the configuration of IT resources to be applied in an apply phase to provide an existing infrastructure plan for the IT infrastructure. The plan file is preferably generated from input to a command line interface that configures the resources and services for the IT infrastructure. The one or more of input variables, outputs, resources, and ephemeral resources are applied at 206. At 208, at least some of the attribute values are designated, implicitly or explicitly as described above, as ephemeral, meaning these values expire at some point during the operation phase (210) of the IT infrastructure, and are not persisted in either the plan file or state file.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An infrastructure as code (IaC) system, comprising:
an IaC tool configured to manage an information technology (IT) infrastructure according to at least one plan file and at least one state file, each plan file comprising attribute values that define a configuration or proposed changes of the configuration of IT resources to be applied in an apply phase to create, update, or delete resources for the IT infrastructure, each state file representing the IT resources of the existing infrastructure for the IT infrastructure, the attribute values comprising one or more of input variables, resources, data sources, output variables, or secrets resources, the IaC tool configured to support a syntax structure for designating one or more of the values as ephemeral so that each designated ephemeral value is not persisted in the at least one plan file or in the at least one state file; and
a user interface having a command line interface for receiving input to perform operations of the IaC tool to manage the IT infrastructure.

2. The IaC system in accordance with claim 1, wherein the secrets resources include one or more of private keys, certificates, or application programming interface (API) tokens.

3. The IaC system in accordance with claim 1, wherein the ephemeral designation for a value configures the value to expire within a predetermined time frame.

4. The IaC system in accordance with claim 1, wherein the IaC engine is configured to track values designated as ephemeral to ensure the designated values are not persisted in the at least one plan file or in the at least one state file after the apply phase.

5. The IaC system in accordance with claim 1, wherein the provider protocol further includes an internal interface to open, close, and renew designated ephemeral resources.

6. The IaC system in accordance with claim 1, wherein the syntax structure is configured to designate ephemeral inputs, outputs, write-only attributes of resources, and ephemeral resources.

7. An infrastructure as code (IaC) system, comprising:
an IaC tool configured to manage an information technology (IT) infrastructure according to at least one plan file and at least one state file, each plan file comprising attribute values that define a configuration or proposed changes of the configuration of IT resources to be applied in an apply phase to provide an existing infrastructure plan for the IT infrastructure, each state file representing the IT resources of the existing infrastructure plan for the IT infrastructure based on the apply phase of the plan file, the IaC tool generating a configuration file having a syntax structure configured to designate one or more of the attribute values as ephemeral so that each designated attribute value is not persisted in the at least one plan file or in the at least one state file after the apply phase to provision the existing infrastructure plan for the IT infrastructure; and
a user interface having a command line interface for receiving input to perform operations of the IaC tool to manage the IT infrastructure.

8. The IaC system in accordance with claim 7, wherein the attribute values include one or more of input variables, secrets resources, connection resources, or write-only resource attributes related to the IT resources.

9. The IaC system in accordance with claim 8, wherein the secrets resources include one or more of private keys, certificates, or application programming interface (API) tokens.

10. The IaC system in accordance with claim 7, wherein the ephemeral designation for an attribute value configures the attribute value to expire within a predetermined time frame.

11. The IaC system in accordance with claim 7, wherein the IaC engine is configured to track attribute values designated as ephemeral to ensure the designated attribute values are not persisted in the at least one plan file or in the at least one state file after the apply phase.

12. The IaC system in accordance with claim 7, wherein the user interface further includes an internal interface to open, close, and renew designated ephemeral attribute values.

13. A method comprising
planning, with an infrastructure as code (IaC) tool, an information technology (IT) infrastructure according to at least one plan file, each plan file comprising attribute values that define a configuration or proposed changes of the configuration of IT resources of the IT infrastructure;
managing, with the infrastructure as code (IaC) tool, the IT infrastructure according at least one state file, each state file representing the IT resources of an existing infrastructure plan for the IT infrastructure based on applying the plan file in an apply phase, the IaC tool configured to support a syntax structure for designating one or more of the attribute values as ephemeral so that each designated attribute value is not persisted in the at least one plan file or in the at least one state file after the apply phase to provision the existing infrastructure plan for the IT infrastructure;
applying, by the IaC tool, the proposed changes of the configuration of IT resources to provide the existing infrastructure plan for the IT infrastructure, the attribute values comprising one or more of input variables, secrets resources, connection resources, or write-only resource attributes; and
receiving, via a user interface having a command line interface, input to create the at least one plan file.

14. The method in accordance with claim 13, wherein the secrets resources include one or more of private keys, certificates, or application programming interface (API) tokens.

15. The method in accordance with claim 13, wherein the ephemeral designation for an attribute value configures the attribute value to expire within a predetermined time frame.

16. The method in accordance with claim 13, wherein the IaC engine is configured to track attribute values designated as ephemeral to ensure the designated attribute values are not persisted in the at least one plan file or in the at least one state file after the apply phase.

17. The method in accordance with claim 13, wherein the user interface further includes an internal interface to open, close, and renew designated ephemeral attribute values.
